(19) United States
(12) Patent Application Publication
(10) Pub. No.: US 2005/0208244 A1
(43) Pub. Date: Sep. 22, 2005

(54) Method and device for production of a bottle stopper from polymers

(76) Inventor: Pierre-Andre Delmas, Perpignan (FR)

Correspondence Address: YOUNG & THOMPSON, 745 SOUTH 23RD STREET, 2ND FLOOR, ARLINGTON, VA, 22202, US

(21) Appl. No.: 10/517,811

(22) PCT Filed: Jun. 12, 2003
(86) PCT No.: PCT/FR03/01762

§ 371 Date: Dec. 14, 2004

(30) Foreign Application Priority Data
Jun. 12, 2002 (FR) 02/07352

(51) Int. Cl. B29D 22/00; B32B 3/26

(52) U.S. Cl. 428/36.5; 428/304.4; 428/314.8; 215/355

(57) ABSTRACT

The object of the invention is a process for production of a bottle stopper, particularly for wine bottles, from polymers, characterized in that it comprises the following series of steps: a) homogenizing and/or mixing a single polymer material based on at least VAE (vinyl acetate ester), by bringing it to temperature, in an extruder comprising a single casing and one screw as well as an outlet nozzle, b) injecting at least one gas under pressure into this single material, c) shaping the material through the nozzle of said extruder in the form of an extrusion of predetermined diameter, and d) cutting of said extrusion to form stoppers of this same diameter. The invention also covers the associated device.

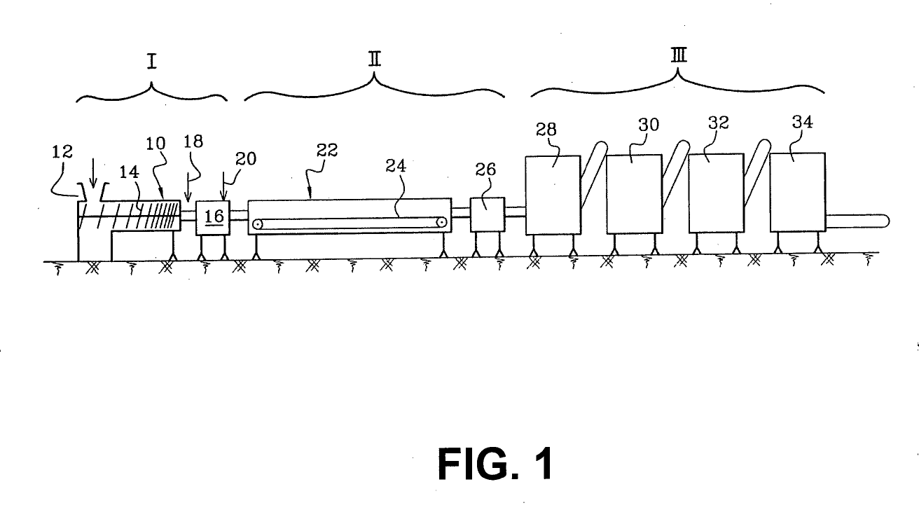

The present invention relates to a process for the production of a bottle stopper, particularly wine bottles, from polymers and by direct injection of gas.

The invention also covers the device associated with the process and permitting its practice.

It is known that bottles, particularly of wine, require a stopping of the neck after filling. This stopping is carried out by introduction into the neck of a stopper which has always been made of cork, more particularly for high quality wine which it is known must be preserved for several tens of years for the great vintages.

The stopping is not simply a mechanical activity must remains a complicated operation.

A stopper must thus ensure sealing against the flow of liquid contained in the bottle because that is its principal function.

This operation is carried out by generally cutting to size a cylindrical stopper of a given length and diameter so as to adapt it to the dimensions of the neck. The diameter is of course greater than that of the neck so as to require forcible introduction.

This permits the stopper to exert by its intrinsic elastic force of the material, namely cork, a substantial radial force which, connected to the coefficient of friction of the cork on the glass, ensures holding of the stopper in the neck of the bottle, no matter what the conditions of pressure or variations of temperature.

To permit its introduction in a suitable manner, the stopper is also subjected to a surface treatment such as a deposition of a coating of silicone base or paraffin. This treatment permits also causing the stopper to slide between the jaws which permit the immediate compression upstream of the introduction phase.

Moreover, this coating also plays a role in the sealing at the stopper/glass interface.

Cork has very interesting resilient characteristics and this is why it is used for most stopping.

Moreover, in the case of beverages which are alcoholic or not, the cork remains neutral and does not disturb the organoleptic properties of the liquid contained unless poor quality cork is used which degrades and disturbs the taste of the products over time.

The stoppers are obtained by cutting out perpendicularly to the thickness of the bark removed from the cork tree, which gives rise to substantial loss between the cutout cylinders.

If it is desired to obtain quality corks, it is necessary to make them of a single piece. This is preferable for emplacement, for the preservation, but also for drawing the cork when opening the bottle because the risks of transverse breakage are avoided, the stopper being monolithic.

It is thus necessary to make the cutouts from thick pieces of cork, which requires waiting of the order of 10 to 15 years between two debarking of the cork trees.

The problem is that the cork market is substantially decreased because entrepreneurs would rather raise more valuable vegetation than cork trees.

Moreover, stripping the bark is a delicate operation and skilled personnel are disappearing.

However, the stopper market is of the order of about 10 billion worldwide, which poses a problem.

Solutions have been proposed and sold as stoppers reconstituted from powder and pieces of cork without however every giving total satisfaction.

Thus, when the stoppers are of reconstituted cork, it is not a question of achieving the quality of cork and the final result will be decreased in quality by the presence of pieces of cork adapted to break off.

Moreover, in this case, it is necessary also to stock cork.

Solutions have been proposed to make it unnecessary to use cork as a primary material.

To overcome the shortage of cork, it is necessary be able to produce a synthetic stopper, but such a stopper must necessarily have mechanical characteristics at least equivalent to natural cork stoppers and also remain neutral as to the organoleptic properties as well as remaining in a commercially acceptable price range.

The material used must be accepted by the food industry and avoid any release of toxic molecules under the action of the product stored in the bottle and this over very long periods of time.

There is known from International patent application No. PCT/US98/07407 a synthetic stopper which is made from plastic material.

This stopper comprises a core of plastic foam material and an external layer connected to the core and also made of plastic material, the technique being carried out by co-extrusion.

The difficulty of using such a process resides in the parameters of adjustment because it is necessary to control in parallel two materials, one of the polymer foam type, and the other of the thermoplastic elastomer type, and to extrude these two materials simultaneously. Thus, as is indicated in this prior art document, the process is very delicate with very precise tolerances which must be controlled continuously.

Moreover, as it involves a plastic material in the form of a foam, it is necessary to add a nucleating or outgassing agent to produce the core and to use catalysts of which certain ones cited are adapted to release toxic molecules when polymerization is incomplete, which requires a very careful control of the steps of the process.

One of the objects of the invention is to provide a process which leads to the production of corks of synthetic material that are industrially producible.

Moreover, the practice of this process must be carried out under normal usage conditions, by the use of material whose cost is in agreement with commercial prices of stoppers.

The invention also covers the corresponding material.

To this end, the process and the required device will now be described in detail according to a preferred embodiment, with reference to the accompanying single FIGURE which represents a simplified view of the device permitting the practice of the steps of the process.

The process according to the present invention consists in using a so-called extrusion technique of a single polymer composition with injection of foaming gas.

A single screw is advantageously used, because it is of easier manufacture and it is less costly, which renders the process more industrially attractive.

On the other hand, the single screw is used because it leads to better control of the temperatures and pressures of the material on the axis of the screw.

In the case of a twin screw for example, it is known that there can be produced a temperature peak in the central zone, between the two screws.

The process will be described with respect to the device t permit understanding all the details.

The composition used comprises preferably:
50 to 100% of VAE (Vinyl Acetate Ester)
0 to 30% of HDPE (High Density Polyethylene),
0 to 20% of LDBE (Low Density Polyethylene).

This material is introduced into an extruder 10 from a hopper 12, the screw 14 of said extruder ensuring the mixture of the composition.

It will be noted that the fact of using only one screw and not two successive screws permits ensuring continuity of the flow and hence better homogeneity.

The screw also permits carrying out a compression of the material to make it move in a sealed manner between the screw and the casing of the extruder. The material is simultaneously heated during its movement.

The material is then led through the extrusion head 16 of the extruder. One or several inlets 18 permit injecting a gas or a mixture of gases comprising nitrogen and/or CO₂ at a pressure comprised between 1 and 500 bars. It will be noted that the process uses a physical agent to the exclusion of any chemical agent.

This gas or mixture of gases is diffused into the material to be distributed homogeneously therein.

Preferably, the gas is introduced upstream of the extrusion head, namely into the medial section of the screw.

The extrusion head also has one or several other inlets 20 through which are injected one or several covering materials if necessary.

The extrusion head is profiled so as to produce by extrusion a sausage of material in which is included at least one gas, in a homogeneous manner.

This first portion I/ corresponds to the production of the cylindrical extrusion.

In this first portion, the process thus consists in:
a) homogenizing and/or mixing a single material, a VAE base polymer at least, in bringing it to a temperature which permits a cross-linking of the material. It is to be noted that the control of the temperature and environmental conditions are essentially to reach a quality result.
b) injecting at least one gas under pressure into this single material, at at least one point along the screw,
c) if desired injecting at least one coloring material into the material, and
d) shaping through an extrusion nozzle the material in the form of an extrusion of predetermined diameter.

The material used is of food quality because it is VAE based and if desired of polyethylene well known in the food field to permit the production of packaging particularly for bottles of mineral water.

This material is therefore suitable for contact with liquid such as wine or spirits.

The fact of injecting at least one gas under pressure permits generating bubbles in the extrusion because the pressure of the screw is no longer exerted at the outlet of the nozzle, which gives rise to the expansion of the gas previously introduced at the end of phase I/.

The density of the bubbles is altogether controllable knowing that the material is of a given composition and once tested, its physico-chemical characteristics are perfectly known. Tests permit, by acting on the pressure or the profile and speed of rotation of the screw, to determine the pressure, the flow rate and the geometry of the points of injection.

It will be noted that the extrusion at the outlet of the nozzle remains hotter at its center than at its periphery, which leads to expansion of the bubbles in a way more pronounced at the center than at the periphery, the external layer of polymer material playing the role of an insulator. There is thus provided a closed cell foam.

The desired density is preferably comprised between 0.2 and 0.6 g/cm³.

Moreover, at the outlet, the cross-section of the polymeric material and the friction of the polymer against the wall of the nozzle gives rise to the formation at the surface of a skin. This skin, although smooth and of closed porosity, has an appearance comparable to human skin with series of very slight depressions.

To obtain a high quality skin with a surface condition suitable for the desired application, the process provides spraying water to control the degree of humidity of the surrounding atmosphere.

In a perfected manner, there is introduced coloring material at the outset and, combined with the extrusion under pressure, this coloring material gives rise to the formation of veins very much like natural cork, not only at the surface but also throughout the thickness according to the conditions of the practice.

This step is altogether optional but if it is to be carried out, there could be noted that it is easily included in the production process, without separate handling of the stoppers and without a specific material.

This optional step does not disturb temperature control. It is altogether possible to color the material throughout and to generate veins throughout its thickness sufficient to remain despite subsequent treatments.

The stopper thus generated is led through a cooling tunnel 22 which constitutes the zone II/ for shaping and cooling. The stopper is conveyed on a movable support 24, synchronized in speed with the speed of extrusion of the nozzle.

This tunnel is of great length because it is necessary to be able to cool the material throughout such that it will reach a stabilization temperature. However, as has been indicated, the material being an insulator, the heat generated by raising the temperature and by the exothermic reaction of cross-linking, it is difficult to dispel.

A control of the gaseous atmosphere both as to its composition and as to its temperature permits confining the stopper to a given temperature profile during its movement through said tunnel. There can be added any supplemental cooling means such as water spraying.

The stopper, once cooled to a sufficient temperature that the material is stabilized, is pre-cut out in a sectioner 26 to constitute sections separated from the principal monolithic extrusion from the extruder, which sections are adapted to be manipulated without disturbing the continuous extrusion upstream thereof.

This portion II/ permits having sections of a constant diameter, cooled and hence stabilized.

Portion III/ constitutes the finishing zone.

The sections having been cut off, their temperature is substantially ambient temperature because the excess heat has been evacuated through the cutoff ends.

At station 28, each section is cut to the exact dimensions to constitute a rough stopper.

This stopper has the production diameter and a length suitable to the neck which must ultimately received it, as a function of the needs determined by the bottler.

At station 30, these rough stoppers are rubbed down at their ends, on the transverse cutoff surfaces. To obtain a suitable surface condition, it is possible to use a heating step of the two end surfaces to render them totally smooth and flat. The closed porosities, which could be opened during sectioning or smoothing, will thus be closed again.

At station 32, the stoppers are rubbed down on their peripheral surfaces, by rolling, which permits obtaining a perfectly cylindrical stopper and a surface condition suitable to co-act in a sealing manner with the wall of the neck against which it will be pressed.

At station 34, the finished stoppers are chamfered, which eliminates the scraps of material on the edges. Moreover, the chamfered shape facilitates the introduction of the stopper or at least the positioning and starting of the introduction.

As needed, the stoppers thus smoothed can be used as such.

If necessary, it is possible to provide a supplemental treatment step of the surface, such as coating with several microns of a silicone material or paraffin.

This surface treatment facilitates the emplacement of the stopper.

Thus, the stopper has a diameter greater than that of the neck which receives it.

This stopper is compressed between jaws to give it a diameter less than or equal to that of the neck, then it is pressed from these jaws forcibly into the neck. The surface treatment is of interest in certain cases of high compression.

Once introduced into the neck, the material has the tendency to spring back to its dimensions before compression and because of this exerts on the walls of the neck a high pressure which ensures sealing.

The surface process has a second use because it stops possible micro-passages which would remain between the external wall of the stopper and the internal wall of the neck.

Contrary to the teaching of the prior art, the choice of the materials and the process according to the invention permit producing a synthetic stopper of a single material, monolithic, which has qualities at least equivalent to those of cork and fulfills all the parameters necessary for stopping because it must be remembered that the object is not necessarily to resemble a natural material but to fulfill the functions necessary for quality stopping.

1. Process for production of a bottle stopper, particularly for wine bottles, from polymers, characterized in that it comprises the following series of steps:
a) homogenizing and/or mixing a single polymeric material at least of VAE (vinyl acetate ester) base, by bringing it to temperature, in an extruder comprising a single casing and one screw as well as an outlet nozzle,
b) injecting at least one gas under pressure into this single material,
c) shaping the material through the nozzle of said extruder in the form of an extrusion of predetermined diameter, and
d) cutting of said extrusion to form stoppers of this same diameter.

2. Process for production according to claim 1, characterized in that there is introduced at least one coloring material into the material at the outset and in that the injection of gas is carried out upstream of the nozzle.

3. Process for production according to claim 1, characterized in that there is injected a gas to obtain a final density of the product comprised between 0.2 and 0.6 g/cm³.

4. Process for production according to claim 1, characterized in that there is associated with the VAE of the single material other polymers selected from high and low density polyethylenes.

5. Process for production according to claim 4, characterized in that there is introduced the different compounds to reproduce the single material:
50 to 100% of VAE (vinyl acetate ester)
0 to 30% of HDPE (High density polyethyelene),
0 to 20% of LDPE (Low density polyethylene).

6. Process for production according to claim 1, characterized in that there are carried out finishing operations on the cutoff stopper.

7. Device for practicing the process according to claim 1, characterized in that it comprises an extruder (10) with a hopper (12) adapted to receive a polymer or a mixture of polymers forming a single material, one screw (14), an extrusion head (16), one or several inlets (18) permitting injecting a gas or a mixture of gases at a pressure comprised between 1 and 500 bars.

8. Device for practicing the process according to claim 7, characterized in that it comprises one or several other inlets (20) through which are injected one or several coloring materials.

9. Device for practicing the process according to claim 7, characterized in that it comprises a cooling tunnel (22) juxtaposed to the extruder, at the outlet of the extrusion head (16).

10. Device for practicing the process according to claim 1, characterized in that it comprises a station for spraying water to obtain a skin on the surface of the stopper.

11. Device for practicing the process according to claim 7, characterized in that it comprises finishing means, such as a cutting station (20), a station (30) for smoothing the transverse cut surfaces, a station (32) for smoothing the peripheral surfaces, by rolling, a station (34) for chamfering the stoppers and if desired a surface treatment station.

12. Device for practicing the process according to claim 11, characterized in that it comprises a heating station for the surfaces of the stopper so as to obtain flat and smooth surfaces.
